(19) United States
(12) Patent Application Publication
(10) Pub. No.: US 2019/0021539 A1
(43) Pub. Date: Jan. 24, 2019

(54) COFFEE BREWING CUP STRUCTURE WITH EXPANDABLE FILTER

(71) Applicant: Tzu-Chi LIN, Taipei (TW)

(72) Inventor: Tzu-Chi LIN, Taipei (TW)

(21) Appl. No.: 15/875,046

(22) Filed: Jan. 19, 2018

(30) Foreign Application Priority Data
Jul. 19, 2017 (TW) 106124106

(51) Int. Cl. A47J 31/06

(52) U.S. Cl. CPC A47J 31/0621

(57) ABSTRACT

The present invention provides a coffee brewing cup structure with an expandable filter. The coffee brewing cup structure comprises: a cup wall; and a substrate which is bonded to the inner side of the cup wall and is a filter. The filter has at least one expandable folded unit. With the implementation of the present invention, when the coffee is brewed, the contact area of water with coffee and the flow rate of brewing can be increased, and the quality and efficiency of brewing can be enhanced.

### BACKGROUND OF THE INVENTION

### 1. Technical Field

The present invention relates to a coffee brewing cup structure with an expandable filter. More particular, the present invention relates to a coffee brewing cup structure with an expandable filter which is used to brew coffee.

### 2. Description of Related Art

The global consumption market for people's livelihood is thriving, and the performance of the beverage market therein makes a great contribution. With the development of the beverage market so far, there are too many varieties to see. Global consumers do not stick to traditional preferences any more, and start to try different beverage varieties. One of examples is the flourish of the global market of coffee, tea, scented tea, fruit tea, traditional Chinese medicine health-care tea, etc.

In terms of coffee, as caffeine can stimulate the central nervous system, the brain is clear in a short time, working efficiency can be increased, and both attention and reaction become fast. Caffeine can also help to decrease the difficulty of exercise and increase the performance of exercise. Caffeine also has the effect of constricting the blood vessel, and thereby can treat the headache symptom caused by blood vessel expansion. Therefore, coffee has gradually become an indispensable part of people's lives, even a part of life style. However, to achieve the goal of health and taste, the design of a filter cup for brewing coffee takes a lot of learning.

When a piece of conventional manual brewing paper filter is used, it must go with a V-shaped paper filter holder, due to its V-shaped structure. Thus, the conventional manual brewing paper filter has the problem of inconvenience in carrying. Moreover, the V-shaped structure of the brewing paper filter always leads the brewed coffee powder to be piled and pressed excessively, and the brewed coffee powder cannot be effectively spread out to contact the brewing liquid uniformly, so that the essence of the coffee cannot be extracted out. As a result, not only is the flavor of the brewed coffee affected severely, but also the problem of low water discharge efficiency of coffee brewing is caused.

### BRIEF SUMMARY OF THE INVENTION

The present invention relates to a coffee brewing cup structure with an expandable filter, which is mainly intended to solve problems, such as increasing brewing flow velocity during coffee brewing.

The present invention provides a coffee brewing cup structure with an expandable filter, comprising: a cup wall; and a substrate which is bonded to an inner side of the cup wall and is a filter. The filter has at least one expandable folded unit.

Implementation of the present invention at least involves the following advantageous effects:

1. Coffee flavor is better in the process of coffee brewing; and

2. The efficiency of coffee brewing is increased.

### BRIEF DESCRIPTION OF THE SEVERAL VIEWS OF THE DRAWINGS

FIG. 1 is a three-dimensional schematic drawing of a coffee brewing cup structure with an expandable filter according to an embodiment of the present invention;

FIG. 2A is a sectional view of a coffee brewing cup structure with an expandable filter according to an embodiment of the present invention;

FIG. 2B is a top view of FIG. 2A;

FIG. 3A is a sectional view of a coffee brewing cup structure with an expandable filter according to another embodiment of the present invention;

FIG. 3B is a top view of FIG. 3A;

FIG. 4 is a schematic drawing of a cup wall provided with a first coated layer or a second coated layer according to an embodiment of the present invention;

FIG. 5A is a schematic drawing showing a coffee brewing cup structure with an expandable filter fastened in a container according to an embodiment of the present invention;

FIG. 5B is a schematic drawing showing a coffee brewing cup structure with an expandable filter arranged at a top end of a container according to an embodiment of the present invention;

FIG. 6 is a schematic drawing showing a coffee brewing cup structure with an expandable filter after water is added for brewing according to an embodiment of the present invention; and

FIG. 7 is a schematic drawing showing an expandable filter which is expanded according to an embodiment of the present invention.

### DETAILED DESCRIPTION OF THE INVENTION

For the purpose of understanding the technical characteristics, contents, advantages and the effectiveness of the present invention, the present invention will collaborate with the drawings and embodiments to express as followings. The drawings are only for indicated and auxiliary specification and not the true proportion and precise configuration. Hence, it should not be according to the proportion of the drawing and the configuration relationship to interpret and limit the scope of the right.

The terms used in the present invention, unless otherwise they are specially stated, they usually have the common meanings in this field, the content disclosed herein and the particular content. Some terms are described in this followings or discussed elsewhere of this specification to provide additional guidance for those skilled people in the art in this disclosure.

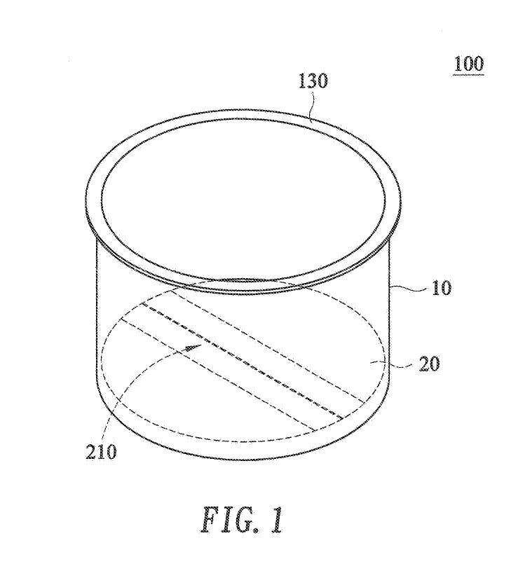

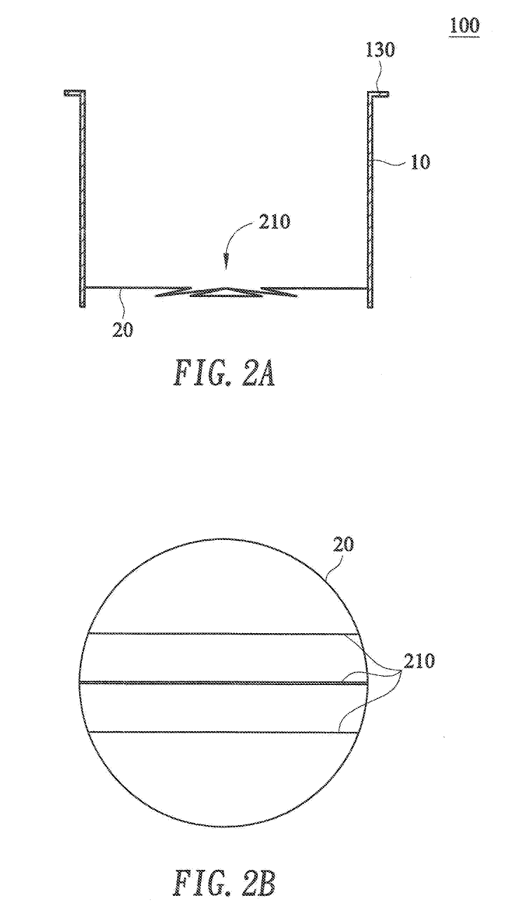

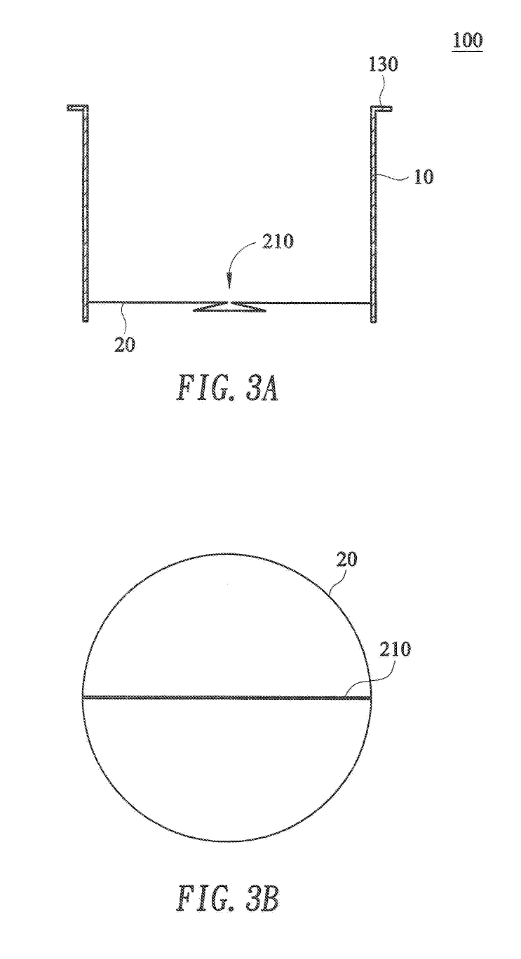

As shown in FIG. 1 to FIG. 3B, the embodiments of the present invention provide a coffee brewing cup structure 100 with an expandable filter, which comprises a cup wall 10 and a substrate 20. The substrate 20 is bonded to an inner side of the cup wall 10, the substrate 20 is a filter, and the filter has at least one expandable folded unit 210.

The cup wall 10 can be made of PLA (polylactic acid), PP (polypropylene), PE (polyethylene) or PET (polyethylene terephthalate). The cup wall 10 can has a drum-shaped structure.

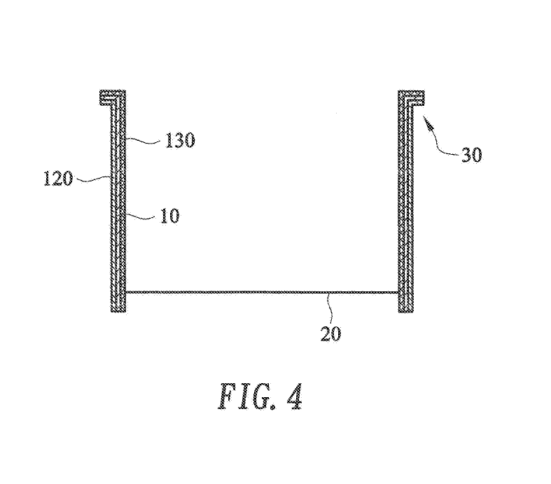

As shown in FIG. 4, the cup wall 10 can also be made of a paper material. At this point, the cup wall 10 has an inner surface and an outer surface, and in order to prevent the permeation of water or other contamination, a first coated layer 110 can be arranged on the inner surface and a second coated layer 120 can be arranged on the outer surface. The first coated layer 110 or the second coated layer 120 can be a PLA, PP, PE or PET coated layer.

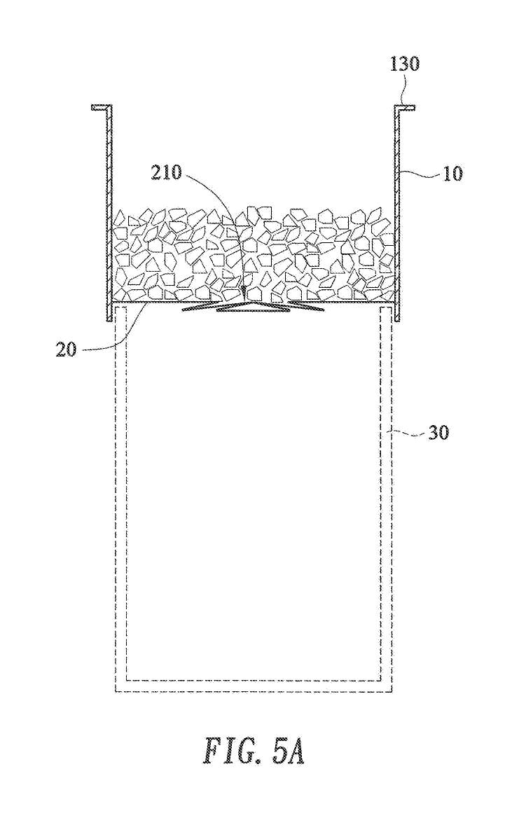

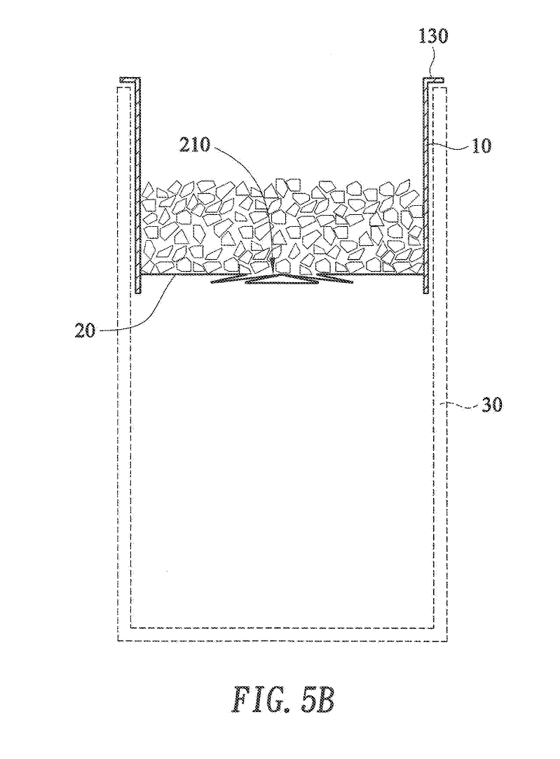

As shown in FIG. 5A to FIG. 5B, during coffee brewing, the coffee brewing cup structure 100 with the expandable filter can be fastened at the top end of a container 30, or can span the top end of the container 30, and the container 30 can receive brewed coffee liquid. The coffee brewing cup structure can further have an annular flange 130 formed at the top end of the cup wall 10 for fastening the coffee brewing cup structure 100 at the top end of the container 30. By fastening the annular flange 130 at the opening of the container 30, coffee brewing can be conveniently carried out.

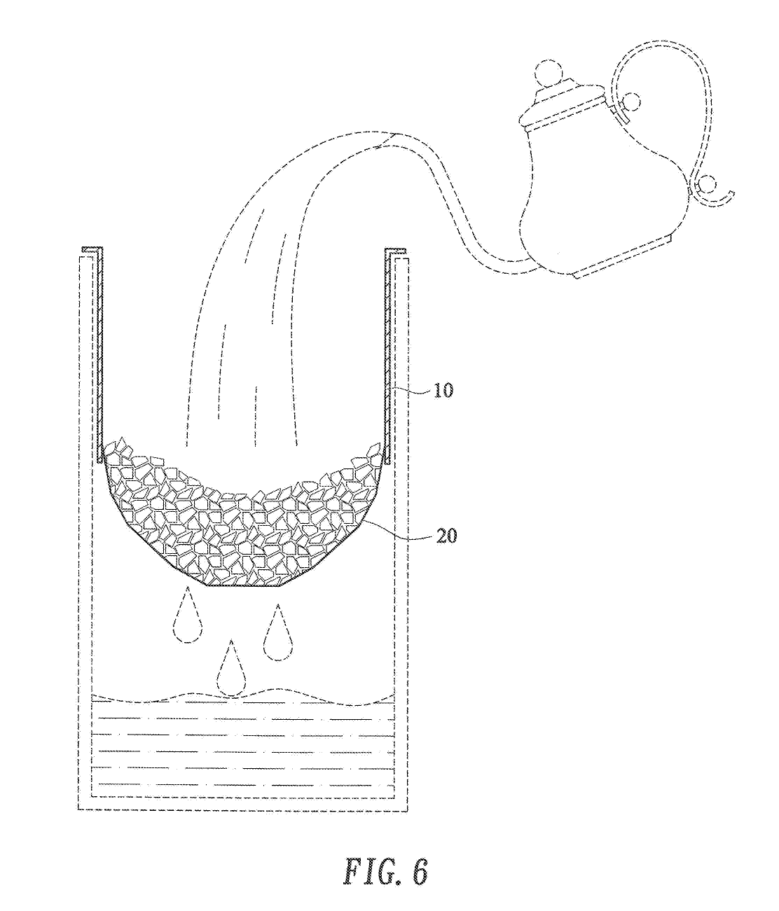

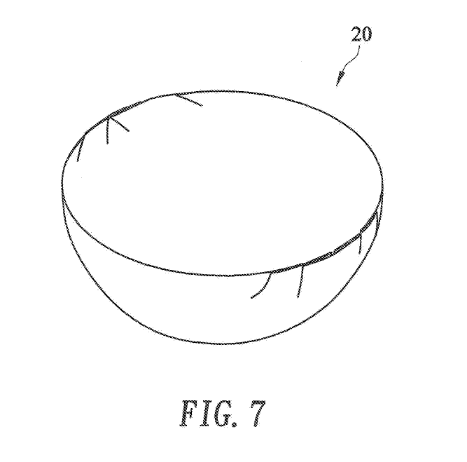

As shown in FIG. 6 to FIG. 7, the substrate 20 is bonded to an inner side of the cup wall 10, the substrate 20 is formed by a filter, and the filter is provided with at least one expandable folded unit 210.

The expandable folded unit 210 folds at least one part of the mesh surface of the filter. When coffee powder is poured into the coffee brewing cup structure 100 and brewed, the expandable folded unit 210 of the filter can be pressed by weight of the coffee powder to spread out, because the weight is increased after the coffee powder absorbs water. As the expandable folded unit 210 is pressed by weight to open up, the contact area between the coffee powder and the brewing water is enlarged, in addition, the brewing and filtering area of the filter is also enlarged. Consequently, the flavor can be better in the process of coffee brewing, and the efficiency of brewing is also increased.

The filter of the coffee brewing cup structure 100 can be a PLA filter, a PP filter, a PE filter, a PET filter or a coffee filter paper. Because the coffee filter paper can filter cafestol, the coffee flavor can be better, and in addition, bad cholesterol can be prevented from being caused in human body.

The features of the present invention are disclosed above by the preferred embodiment to allow persons skilled in the art to gain insight into the contents of the present invention and implement the present invention accordingly. The preferred embodiment of the present invention should not be interpreted as restrictive of the scope of the present invention. Hence, all equivalent modifications or amendments made to the aforesaid embodiment should fall within the scope of the appended claims.

What is claimed is:

1. A coffee brewing cup structure with an expandable filter, comprising:
a cup wall; and
a substrate bonded to an inner side of the cup wall, wherein the substrate is a filter, and the filter is provided with at least one expandable folded unit.

2. The coffee brewing cup structure according to claim 1, wherein the cup wall is made of PLA, PP, PE or PET.

3. The coffee brewing cup structure according to claim 1, wherein the cup wall is made of a paper material.

4. The coffee brewing cup structure according to claim 3, wherein the cup wall has an inner surface and an outer surface, and the inner surface is provided with a first coated layer.

5. The coffee brewing cup structure according to claim 4, wherein the first coated layer is a PLA, PP, PE or PET coated layer.

6. The coffee brewing cup structure according to claim 3, wherein the cup wall has an inner surface and an outer surface, and the outer surface is provided with a second coated layer.

7. The coffee brewing cup structure according to claim 6, wherein the second coated layer is a PLA, PP, PE or PET coated layer.

8. The coffee brewing cup structure according to claim 1, further comprising an annular flange formed at a top end of the cup wall.

9. The coffee brewing cup structure according to claim 1, wherein the cup wall has a drum-shaped structure.

10. The coffee brewing cup structure according to claim 1, wherein the filter is a PLA filter, a PP filter, a PE filter, a PET filter, or coffee filter paper.
